(19) United States
(12) Patent Application Publication
(10) Pub. No.: US 2022/0062994 A1
(43) Pub. Date: Mar. 3, 2022

(54) DISSIMILAR MATERIAL JOINING PRODUCT, BASE PLATE FOR ADDITIVE MANUFACTURING, ADDITIVE MANUFACTURING APPARATUS, AND ADDITIVE MANUFACTURING METHOD

(71) Applicant: MITSUBISHI HEAVY INDUSTRIES, LTD., Tokyo (JP)

(72) Inventors: Takahiro TACHIBANA, Tokyo (JP); Noriyuki HIRAMATSU, Tokyo (JP); Yohei KATO, Tokyo (JP); Masashi KITAMURA, Tokyo (JP); Shuji TANIGAWA, Tokyo (JP)

(21) Appl. No.: 17/373,983

(22) Filed: Jul. 13, 2021

(30) Foreign Application Priority Data
Aug. 27, 2020 (JP) 2020-143584

(51) Int. Cl. B22F 10/28; B22F 12/30; B22F 12/41; B22F 12/55; B33Y 10/00; B33Y 30/00; B33Y 70/00

(52) U.S. Cl. CPC B22F 10/28; B22F 12/30; B22F 12/41; B22F 12/55; B22F 2301/35; B33Y 30/00; B33Y 70/00; B22F 2301/205; B33Y 10/00

(57) ABSTRACT

A dissimilar material joining product according to at least one embodiment of the disclosure includes a base material, a cladding layer formed of a dissimilar material having a different main component element from that of the base material and formed to cover at least a part of the base material, and an additively manufactured layer formed of a dissimilar material having a different main component element from that of the base material and joined to the base material with the cladding layer interposed therebetween.

### CROSS-REFERENCE TO RELATED APPLICATIONS

This application claims the benefit of priority to Japanese Patent Application Number 2020-143584 filed on Aug. 27, 2020. The entire contents of the above-identified application are hereby incorporated by reference.

### TECHNICAL FIELD

The disclosure relates to a dissimilar material joining product, a base plate for additive manufacturing, an additive manufacturing apparatus, and an additive manufacturing method.

### RELATED ART

In recent years, an additive manufacturing method for obtaining a three-dimensional object by layering and fabricating metal has been used as a method of manufacturing various metal products. For example, in an additive manufacturing method using a powder bed method, a three-dimensional object is formed by repeatedly welding and solidifying to layer through irradiating layered metal powder with an energy beam such as a light beam or an electron beam (for example, refer to Japanese Patent No. 6405028).

Also, for example, an additive manufacturing method using a laser metal deposition (LMD) method is disclosed to produce a joined member in which dissimilar materials are joined (see, for example, International Publication WO 2017/110001).

### SUMMARY

For example, in the additive manufacturing method using the powder bed method described in Japanese Patent No. 6405028, a fabricated object is formed on a base plate. The additive manufacturing method using the LMD method described in WO 2017/110001 may be used to form a fabricated object on a base plate. When a fabricated object of dissimilar materials in which a main component element is different from that of a base plate is formed on the base plate, and the combination of the metal material constituting the base plate and the metal material constituting the fabricated object is such a combination that produces an intermetallic compound, for example, the intermetallic compound generates a weakened region at the interface between the base plate and the fabricated object. Thus, when the combination of the metal material constituting the base plate and the metal material constituting the fabricated object is combination such as that described above, the fabricated object is peeled from the base plate during manufacturing, whereby additive manufacturing cannot be continued.

In addition, when additive manufacturing is performed using the LMD method, for example, by melting and solidifying powder of a dissimilar material (a second metal) having a main component element that is different from that of a member made of a certain type of metal (a first metal) on a surface of the member to form a layer of the second metal, a dissimilar material joining product can be produced. However, as described above, depending on the combination of the first metal and the second metal, the intermetallic compound of the first metal and the second metal generates a weakened region at the joining interface between the first metal and the second metal. When such a weakened region is generated at the joining interface, the joining strength between the first metal and the second metal at the joining interface decreases, and the strength of the dissimilar material joining product decreases.

In view of the circumstances described above, an object of at least one embodiment of the disclosure is to improve the joining strength of a portion formed of dissimilar materials having different main component elements in a dissimilar material joining product including the portion.

(1) A dissimilar material joining product according to at least one embodiment of the disclosure includes:

a base material;

a cladding layer formed of a dissimilar material having a different main component element from that of the base material and formed to cover at least a part of the base material; and

an additively manufactured layer formed of a dissimilar material having a different main component element from that of the base material and joined to the base material with the cladding layer interposed therebetween.

(2) A dissimilar material joining product according to at least one embodiment of the disclosure includes:

a base material;

a cladding layer formed of a dissimilar material having a different main component element from that of the base material and formed to cover at least a part of the base material; and

an additively manufactured layer formed of a dissimilar material having a different main component element from that of the base material and layered and fabricated on the cladding layer.

(3) A base plate for additive manufacturing according to at least one embodiment of the disclosure includes:

a substrate; and

a cladding layer formed of a dissimilar material having a different main component element from that of the substrate and formed to cover at least a part of the substrate.

(4) An additive manufacturing apparatus according to at least one embodiment of the disclosure includes the base plate for additive manufacturing having the configuration (3) described above.

(5) An additive manufacturing method according to at least one embodiment of the disclosure includes a step of forming an additively manufactured layer on a cladding layer by melting, with an energy beam, a raw material of a dissimilar material having a different main component element from that of a substrate on a base plate for additive manufacturing and solidifying the raw material, including the substrate and the cladding layer formed of a dissimilar material having a different main component element from that of the substrate and formed to cover at least a part of the substrate.

In accordance with at least one embodiment of the disclosure, the joining strength of a portion formed of dissimilar materials having different main component elements can be improved in a dissimilar material joining product including the portion.

### BRIEF DESCRIPTION OF DRAWINGS

The disclosure will be described with reference to the accompanying drawings, wherein like numbers reference like elements.

FIG. 1 is a schematic diagram illustrating an overall configuration of an additive manufacturing apparatus, as an apparatus capable of manufacturing a dissimilar material joining product according to at least one embodiment.

FIG. 2 is a schematic perspective view of a base plate according to some embodiments.

FIG. 3A is a flowchart illustrating a processing procedure in an additive manufacturing method according to one embodiment.

FIG. 3B is a flowchart illustrating a processing procedure in an additive manufacturing method according to another embodiment.

FIG. 4A is a side view of a base plate according to one embodiment.

FIG. 4B is a side view of a base plate according to another embodiment.

FIG. 5A is a schematic side view of the base plate illustrated in FIG. 4A and an additively manufactured layer, with the additively manufactured layer being formed on the base plate.

FIG. 5B is a schematic side view of the base plate illustrated in FIG. 4B and an additively manufactured layer, with the additively manufactured layer being formed on the base plate.

FIG. 6 is a schematic perspective view of the base plate and the additively manufactured layer illustrated in FIG. 5A.

FIG. 7A is a schematic side view of a dissimilar material joining product.

FIG. 7B is a schematic side view of an additive manufacturing product.

FIG. 7C is a schematic side view of the additive manufacturing product.

FIG. 8 is a table listing several examples of Young's moduli and proof stresses of ferrous and titanium-based metal materials.

### DESCRIPTION OF EMBODIMENTS

Hereinafter, some embodiments of the disclosure will be described with reference to the accompanying drawings. However, dimensions, materials, shapes, relative arrangements, or the like of components described in the embodiments or in the drawings are not intended to limit the scope of the disclosure thereto, and are merely illustrative examples.

For instance, an expression indicating relative or absolute arrangement such as “in a direction”, “along a direction”, “parallel”, “orthogonal”, “centered”, “concentric” or “coaxial” shall not be construed as indicating only the arrangement in a strict literal sense, but also includes a state where the arrangement is relatively displaced by a tolerance, or by an angle or a distance within a range in which the same function can be achieved.

For instance, an expression indicating an equal state such as “same”, “equal”, or “uniform” shall not be construed as indicating only a state in which features are strictly equal, but also includes a state in which there is a tolerance or a difference within a range in which the same function can be achieved.

Further, for instance, an expression indicating a shape such as a rectangular shape or a cylindrical shape shall not be construed as only being a geometrically strict shape, but also includes a shape with unevenness, chamfered corners or the like within a range in which the same effect can be achieved.

On the other hand, an expression such as “comprise”, “include”, “have”, “contain” or “constitute” is not intended to be exclusive of other constituent elements.

### Additive Manufacturing Apparatus 1

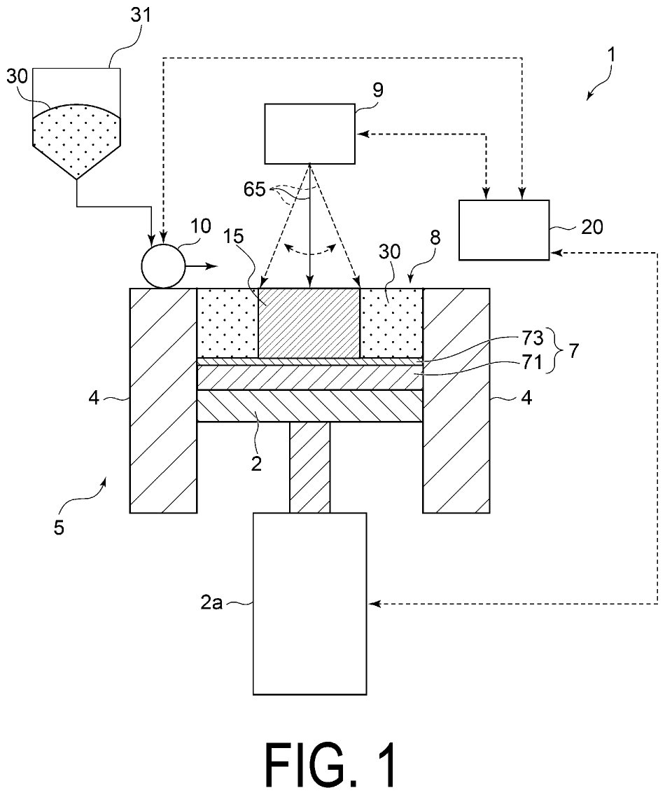

FIG. 1 is a schematic diagram illustrating an overall configuration of an additive manufacturing apparatus 1, as an apparatus capable of manufacturing a dissimilar material joining product according to at least one embodiment of the disclosure. In the following description, an additive manufacturing apparatus that can perform additive manufacturing using a powder bed method is described as an example of the additive manufacturing apparatus 1.

The additive manufacturing apparatus 1 illustrated in FIG. 1 is an apparatus for manufacturing a three-dimensional fabricated object through additive manufacturing by irradiating metal powder that is raw material powder laid in layers with a light beam 65 as an energy beam.

The additive manufacturing apparatus 1 illustrated in FIG. 1 can form, for example, a rotor blade or a stator vane of a turbine such as a gas turbine or a steam turbine, or a component such as a combustor basket, a transition piece or a nozzle of a combustor.

The additive manufacturing apparatus 1 illustrated in FIG. 1 includes a storage unit 31 for raw material powder 30. The additive manufacturing apparatus 1 illustrated in FIG. 1 includes a powder bed forming unit 5 for forming a powder bed 8 of the raw material powder 30 supplied from the storage unit 31.

The additive manufacturing apparatus 1 illustrated in FIG. 1 includes an energy beam irradiation unit 9 capable of irradiating the powder bed 8 with the light beam 65 as an energy beam. Note that in the following description, the energy beam irradiation unit 9 is also referred to as a light beam irradiation unit 9. The additive manufacturing apparatus 1 illustrated in FIG. 1 includes a control device 20 capable of controlling a powder laying unit 10 described later, a drive cylinder 2a for a stage 2, and the light beam irradiation unit 9.

The powder bed forming unit 5 according to some embodiments includes the drive cylinder 2a, a cylinder 4, the stage 2 configured to be lifted and lowered within the cylinder 4 by the drive cylinder 2a, and a base plate 7 for additive manufacturing that can be attached to and detached from the stage 2. Note that in the following description, the base plate 7 for additive manufacturing is also simply referred to as a base plate 7.

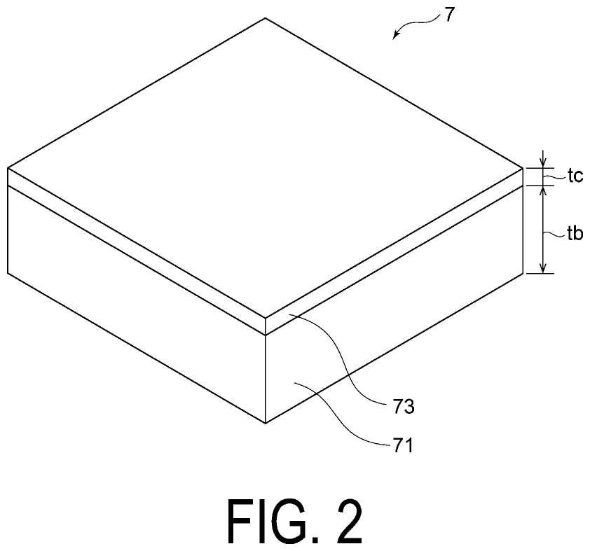

FIG. 2 is a schematic perspective view of the base plate 7 according to some embodiments.

The base plate 7 according to some embodiments serves as a base on which an additively manufactured layer 15 is fabricated. Note that the additively manufactured layer 15 is formed by melting the raw material powder 30 with the light beam 65 and then solidifying the molten powder, as described below. The base plate 7 according to some embodiments includes a substrate 71 and a cladding layer 73 formed to cover at least a part of the substrate 71. The base plate 7 according to some embodiments is detachably fixed to an upper surface of the stage 2 with a fastening member such as a bolt. Note that details of the base plate 7 according to some embodiments will be described later.

The base plate 7 and the stage 2 according to some embodiments are disposed inside the cylinder 4, which has a substantially cylindrical shape with a central axis extending in the vertical direction, so as to be able to be lifted and lowered by the drive cylinder 2a. The powder bed 8 formed on the base plate 7 according to some embodiments is newly formed by laying powder on the upper layer side of the powder bed 8 each time the base plate 7 is lowered in each cycle during manufacturing work.

The additive manufacturing apparatus 1 illustrated in FIG. 1 includes the powder laying unit 10 configured to lay the raw material powder 30 on the base plate 7 to form the powder bed 8. The powder laying unit 10 supplies the raw material powder 30 from the storage unit 31 to the upper surface side of the base plate 7 and flattens the surface of the raw material powder 30, thereby forming the layered powder bed 8 having a substantially uniform thickness over the entire upper surface of the base plate 7. The powder bed 8 formed in each cycle is selectively solidified by being irradiated with the light beam 65 from the light beam irradiation unit 9, and in the next cycle, the raw material powder 30 is laid again on the upper layer side by the powder laying unit 10 to form a new powder bed 8, whereby the powder beds 8 are stacked in layers.

The raw material powder 30 supplied from the powder laying unit 10 is a powdery substance serving as a raw material of the additively manufactured layer 15. For example, a metal material such as iron, copper, aluminum, or titanium, or a non-metal material such as ceramic can be widely used. Note that in the following description, the raw material powder 30 is, for example, powder of a titanium alloy.

The control device 20 illustrated in FIG. 1 is a control unit of the additive manufacturing apparatus 1 illustrated in FIG. 1, and is composed of an electronic computation device such as a computer.

The control device 20 illustrated in FIG. 1 receives input of information on the shape of the additively manufactured layer 15, that is, the dimensions of each part, which is information necessary for manufacturing the additively manufactured layer 15. Information on the dimensions or the like of each part necessary for manufacturing the additively manufactured layer 15 may be input from, for example, an external device and stored in, for example, a storage unit (not illustrated) of the control device 20.

### Material of Base Plate 7

In general, as metal materials used for base plates of additive manufacturing apparatuses, steel materials (iron alloys) such as S45C are often used in terms of the strength and cost required for the base plates.

For example, in the additive manufacturing method using the powder bed method, an additively manufactured layer (fabricated object) is welded on the upper surface of the base plate. Therefore, when the combination of the metal material forming the base plate and the metal material forming the additively manufactured layer (the metal material of the raw material powder) renders their joining by welding difficult, the joining strength between the base plate and the additively manufactured layer cannot be ensured, and the additively manufactured layer (fabricated object) peels from the base plate during manufacturing, and thus additive manufacturing cannot be continued.

Examples of the combination of the metal material forming the base plate and the metal material forming the additively manufactured layer that renders their joining by welding difficult includes such a combination of the metal material constituting the base plate and the metal material constituting the fabricated object (the metal material of the raw material powder) that produces an intermetallic compound, for example.

For example, iron and titanium are such a combination that produces an intermetallic compound. Therefore, when the material of the base plate is a steel material, which is a common material for the base plate as described above, it is difficult to form an additively manufactured layer of a titanium-based metal material, that is, pure titanium or a titanium alloy containing titanium as the main component element, on the base plate.

Thus, for example, the base plate may be made of a titanium-based metal material. However, while the additively manufactured layer is being formed on the base plate, the additively manufactured layer shrinks with heat, resulting in force that warps the base plate acting on the base plate. To counter this, the base plate requires a certain plate thickness from the perspective of ensuring strength.

In general, titanium-based metal materials have smaller Young's modulus and proof stress than those of ferrous metal materials, namely, pure iron or steel materials containing iron as the main component element. For this reason, to ensure that a base plate made of a titanium-based metal material has the same rigidity as a base plate made of a ferrous metal material, it is necessary to make the thickness of the base plate made of a titanium-based metal material larger than that of the base plate formed of a ferrous metal material. In addition, titanium-based metal materials are generally more expensive than ferrous metal materials. As a result, the cost of manufacturing base plates made of titanium-based metal materials is significantly higher than the cost of manufacturing base plates made of ferrous metal materials.

To address this, in the base plate 7 according to some embodiments, the rigidity of the base plate is ensured by the substrate 71 made of a ferrous metal material. In addition, with the base plate 7 according to some embodiments, the cladding layer 73 is formed to cover the substrate 71, and the cladding layer 73 is made of pure titanium, for example, among titanium-based metal materials having the same main component element as the metal material (titanium alloy) of the raw material powder 30. As a result, the joining strength between the cladding layer 73 and the additively manufactured layer 15 made of a titanium alloy and layered and fabricated by additive manufacturing on the cladding layer is ensured.

As described above, the base plate 7 according to some embodiments includes the substrate 71 and the cladding layer 73 formed of a dissimilar material from the substrate 71 and formed to cover at least a part of the substrate 71.

Thus, with the base plate 7 according to some embodiments, even when the combination of the metal material forming the substrate 71 and the metal material forming the additively manufactured layer 15 renders their joining by welding difficult, if the main component element (titanium) of the metal material (pure titanium, for example) forming the cladding layer 73 and the main component element (titanium) of the metal material (a titanium alloy, for example) forming the additively manufactured layer 15 are the same, the additively manufactured layer 15 can be joined to the substrate 71 with relatively high strength with the cladding layer 73 interposed therebetween. Furthermore, if the metal material forming the cladding layer 73 and the metal material forming the additively manufactured layer 15 are a combination capable of producing a solid solution, a layer of the solid solution can be formed at the interface between the cladding layer 73 and the additively manufactured layer 15, and thus the additively manufactured layer 15 can be joined to the substrate 71 with relatively high strength with the cladding layer 73 interposed therebetween.

As a result, for example, even when the combination of the metal material forming the substrate 71 and the metal material forming the additively manufactured layer 15 is a combination that renders their joining by welding difficult, the joining strength between the substrate 71 and the additively manufactured layer 15 with the cladding layer 73 interposed therebetween can be made relatively high. In other words, the joining strength of a portion, that is, the additively manufactured layer 15, formed of a dissimilar material having a different main component element from that of the substrate 71 can be improved in a dissimilar material joining product 100 including the substrate 71 and the additively manufactured layer 15. As a result, for example, even when the combination of the metal material forming the substrate 71 and the metal material forming the additively manufactured layer 15 is a combination that renders their joining by welding difficult, the additively manufactured layer 15 can be formed on the base plate 7 by additive manufacturing.

Note that, as with the base plate 7 according to some embodiments, a joining product including a base material (substrate 71) and a cladding layer (cladding layer 73) made of a dissimilar material from the base material and formed to cover at least a part of the base material can be produced by, for example, explosive welding, hot rolling, cold rolling, and the like. Thus, the base plate 7 according to some embodiments can be produced by explosive welding, hot rolling, cold rolling, and the like.

### Thickness of Base Plate 7

With the base plate 7 according to some embodiments, the thickness of the cladding layer 73 may be relatively small because the rigidity for the base plate is ensured by the substrate 71. Therefore, with the base plate 7 according to some embodiments, even when the cladding layer 73 is made of a titanium-based metal material, which is more expensive than a ferrous metal material, an increase in cost can be suppressed.

Furthermore, with the base plate 7 according to some embodiments, the substrate 71 is made of a ferrous metal material, which has a larger Young's modulus and a higher proof stress than those of titanium-based metal materials. Therefore, the thickness of the base plate 7 can be reduced compared with a case where the base plate is made only of a titanium-based metal material, for example.

That is, with the base plate 7 according to some embodiments, a thickness tb of the substrate 71 is preferably larger than a thickness tc of the cladding layer 73. Furthermore, with the base plate 7 according to some embodiments, Young's modulus of the metal material constituting the substrate 71 is preferably larger than Young's modulus of the metal material constituting the cladding layer 73.

When the metal material constituting the cladding layer 73 is more expensive than the metal material constituting the substrate 71, as with the base plate 7 according to some embodiments, the thickness of the cladding layer 73 is preferably as small as possible. Thus, in this case, from the perspective of ensuring the strength of the base plate 7, the thickness of the substrate 71 is preferably greater than the thickness of the cladding layer 73.

Furthermore, when the metal material constituting the cladding layer 73 is more expensive than the metal material constituting the substrate 71, as with the base plate 7 according to some embodiments, the thickness of the cladding layer 73 is preferably as small as possible. Thus, in this case, from the perspective of ensuring the strength of the base plate 7, Young's modulus of the material constituting the substrate 71 is preferably larger than Young's modulus of the material constituting the cladding layer 73.

Thus, with the base plate 7 according to some embodiments, even when the metal material constituting the cladding layer 73 is more expensive than the metal material constituting the substrate 71, the strength of the base plate 7 can be ensured while suppressing an increase in cost.

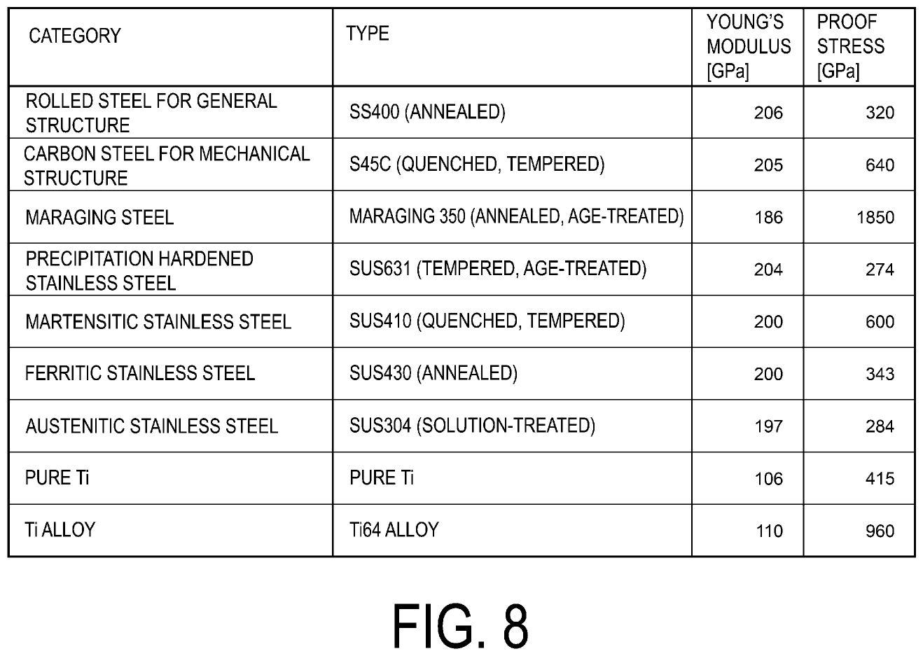

FIG. 8 is a table listing several examples of Young's moduli and proof stresses of ferrous and titanium-based metal materials. As illustrated in FIG. 8, Young's moduli of the ferrous metal materials are larger than Young's moduli of the titanium-based metal materials. Therefore, even when the cladding layer 73 is made of a titanium-based metal material, the strength of the base plate 7 can be easily ensured because the substrate 71 is made of a ferrous metal material.

For example, with the base plate 7 according to some embodiments, as described above, when the material of the substrate 71 is a ferrous material, which is a common material for a base plate as described above, the thickness of the substrate 71 is preferably ensured to have a thickness that is equivalent to the thickness of a known base plate made of a ferrous metal material having no cladding layer 73 from the perspective of ensuring the strength of the base plate 7. Specifically, with the base plate 7 according to some embodiments, the thickness of the substrate 71 is preferably from approximately 30 mm to 40 mm.

Note that, as described below, when at least a part of the base plate 7 serves as a part of the dissimilar material joining product 100, which is a product including the additively manufactured layer 15, the thickness of the substrate 71 may exceed 40 mm, for example. In this case, the upper limit of the thickness of the substrate 71 is dependent on constraints on the apparatus side, such as the powder bed forming unit 5 of the additive manufacturing apparatus 1.

With the base plate 7 according to some embodiments, the thickness of the cladding layer 73 is preferably from 0.5 mm or more to 5 mm or less.

For example, when the additively manufactured layer 15 is formed on the cladding layer 73 by the powder bed method using the base plate 7 according to some embodiments described above, the depth of penetration by irradiation with the light beam 65 is from approximately 0.2 mm to approximately 0.3 mm. Therefore, when the additively manufactured layer 15 is formed on the cladding layer 73 by the powder bed method using the base plate 7 according to some embodiments described above, the thickness of the cladding layer 73 is preferably 0.5 mm or more from the perspective of preventing melting of the substrate 71.

In addition, while the thickness of the cladding layer 73 is preferably greater given that the base plate 7 according to some embodiments described above is repeatedly used, the thickness of the cladding layer 73 is preferably smaller when the metal material forming the cladding layer 73 is relatively expensive, for example, as with titanium-based metal materials compared to ferrous metal materials. Therefore, the thickness of the cladding layer 73 is preferably 5 mm or less, for example.

Thus, by setting the thickness of the cladding layer 73 to from 0.5 mm or more and 5 mm or less, the cladding layer 73 has an appropriate thickness in consideration of the above-described circumstances.

With the additive manufacturing apparatus 1 including the base plate 7 according to some embodiments as a base plate for additive manufacturing, even when the combination of the metal material forming the substrate 71 and the metal material forming the additively manufactured layer 15 is a combination that renders their joining by welding difficult, for example, the additively manufactured layer 15 can be formed on the base plate 7 by additive manufacturing.

### Combinations of Metals Forming Intermetallic Compounds

Examples of the combinations of metals that form intermetallic compounds and thus render their joining difficult even by welding or the like include the following combinations, besides the above-described combination of iron and titanium. For example, a combination of aluminum and iron, a combination of titanium and nickel, and a combination of nickel and molybdenum are combinations that produce intermetallic compounds.

Therefore, a combination of a ferrous metal material and a titanium-based metal material, a combination of an aluminum-based metal material and a ferrous metal material, a combination of a titanium-based metal material and a nickel-based metal material, and a combination of a nickel-based metal material and a molybdenum-based metal material are combinations that are relatively difficult to join by welding.

### Combinations of Metals Producing Solid Solutions

Examples of combinations of metals that can ensure sufficient joining strength by forming solid solutions during the process of being joined by welding or the like include a combination of nickel and cobalt, a combination of nickel and copper, and a combination of titanium and molybdenum. Therefore, for example, a combination of a nickel-based metal material and a cobalt-based metal material, a combination of a nickel-based metal material and a copper-based metal material, a combination of a titanium-based metal material and a molybdenum-based metal material, and the like are combinations that are relatively easy to join by welding.

### Additive Manufacturing Method

Hereinafter, additive manufacturing methods for producing a dissimilar material joining product with the additive manufacturing apparatus 1 including the base plate 7 according to some embodiments described above will be described.

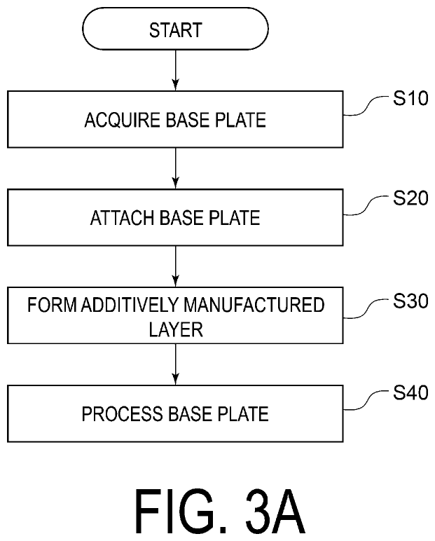

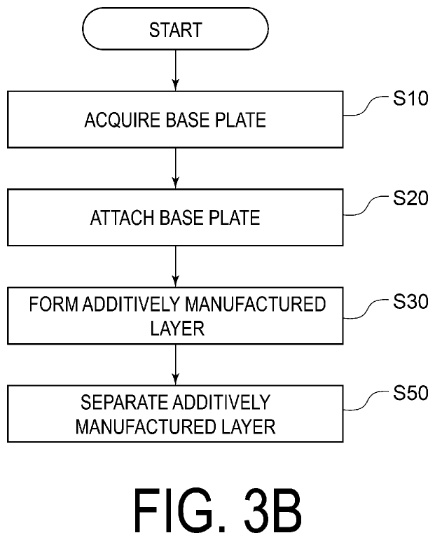

FIG. 3A is a flowchart illustrating a processing procedure in an additive manufacturing method according to one embodiment.

FIG. 3B is a flowchart illustrating a processing procedure in an additive manufacturing method according to another embodiment.

The additive manufacturing methods according to some embodiments illustrated in FIGS. 3A and 3B include an additively manufactured layer forming step S30. The additive manufacturing methods according to some embodiments illustrated in FIGS. 3A and 3B may include a base plate acquiring step S10 and a base plate attaching step S20. The additive manufacturing method illustrated in FIG. 3A may include a base plate processing step S40. The additive manufacturing method illustrated in FIG. 3B may include an additively manufactured layer separating step S50.

### Base Plate Acquiring Step S10

The base plate acquiring step S10 is a step of forming the cladding layer 73 on the substrate 71 to obtain the base plate 7 for additive manufacturing. In the base plate acquiring step S10, the base plate 7, as illustrated in FIG. 2, in which the cladding layer 73 is joined to the substrate 71, is produced by explosive welding, hot rolling, cold rolling, and the like as described above, for example.

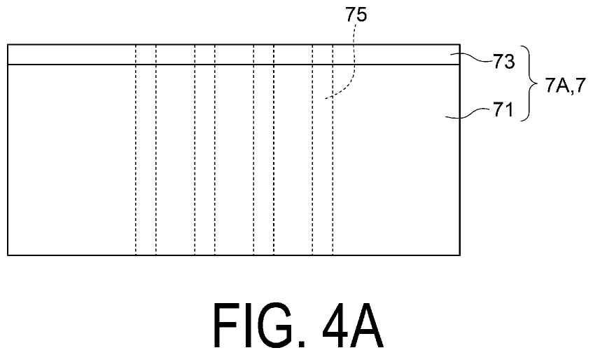

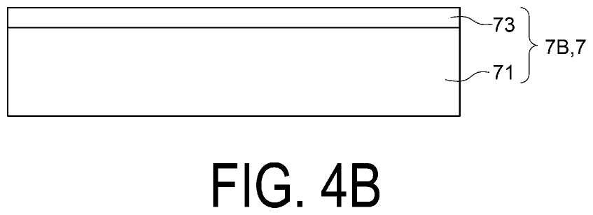

FIG. 4A is a side view of the base plate 7 according to one embodiment. A base plate 7A illustrated in FIG. 4A is a base plate used when at least a part of the base plate 7A serves as a part of the dissimilar material joining product 100, which is a product including the additively manufactured layer 15, as described later. In the base plate 7A illustrated in FIG. 4A, for example, a through-hole first region 75 may be already formed. The through-hole first region 75 corresponds to a part of through-holes 105 provided in the dissimilar material joining product 100, which is a product including the additively manufactured layer 15, for example. In other words, in the base plate acquiring step S10, the through-hole first region 75 may be formed in the substrate 71 and the cladding layer 73, as with the base plate 7A illustrated in FIG. 4A. Note that the through-hole first region 75 in FIG. 4A illustrates an example of processing on the base plate 7A in the base plate acquiring step S10. The processing on the base plate 7A in the base plate acquiring step S10 is not limited to perforation as described above, and includes various types of processing such as performing cutting so as to approximate the form of the dissimilar material joining product 100, which is a product including the additively manufactured layer 15.

Note that in the base plate acquiring step S10, the base plate 7A may be processed to satisfy the thicknesses required for the substrate 71 and the cladding layer 73 as the dissimilar material joining product 100, which is a product including the additively manufactured layer 15.

FIG. 4B is a side view of the base plate 7 according to another embodiment. Unlike the base plate 7A described above, a base plate 7B illustrated in FIG. 4B is a base plate used when at least a part of the base plate 7B does not serve as a part of the dissimilar material joining product 100, which is a product including additively manufactured layer 15. In the base plate 7B illustrated in FIG. 4B, for example, the through-hole first region 75 as described above is not necessarily formed.

With the additive manufacturing method according to some embodiments, the base plate 7 is produced that includes the substrate 71 and the cladding layer 73 formed of a dissimilar material having a different main component element from that of the substrate 71 and formed to cover at least a part of the substrate 71.

Note that, in the base plate acquiring step S10, in order to ensure the flatness of the surface of the base plate 7 (cladding layer 73) already used for additive manufacturing, the base plate 7 that has already been used for additive manufacturing may be removed from the additive manufacturing apparatus 1 to adjust the surface of the base plate 7 (cladding layer 73) by polishing or the like.

### Base Plate Attaching Step S20

The base plate attaching step S20 is a step of attaching the base plate 7 to the upper surface of the stage 2 of the additive manufacturing apparatus 1. In the base plate attaching step S20, the base plate 7 may be fixed to the upper surface of the stage 2 with a fastening member such as a bolt. In the base plate attaching step S20, the base plate 7 is fixed to the upper surface of the stage 2 using, for example, a variety of tools by an operator.

### Additively Manufactured Layer Forming Step S30

The additively manufactured layer forming step S30 is a step of forming the additively manufactured layer 15 on the cladding layer 73 by melting raw material (raw material powder 30) of a dissimilar material having a different main component element from that of the substrate 71 on the base plate 7 with an energy beam (light beam 65) and solidifying the raw material. In the additively manufactured layer forming step S30, the additively manufactured layer 15 is formed on the base plate 7 by, for example, the additive manufacturing apparatus 1 illustrated in FIG. 1.

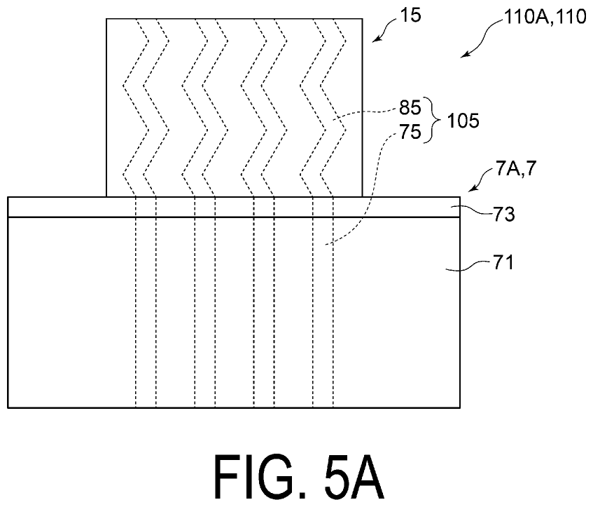

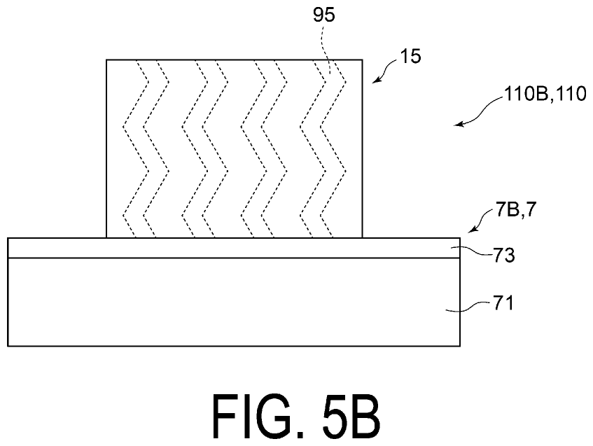

FIG. 5A is a schematic side view of the base plate 7A illustrated in FIG. 4A and the additively manufactured layer 15, with the additively manufactured layer 15 being formed on the base plate 7A.

FIG. 5B is a schematic side view of the base plate 7B illustrated in FIG. 4B and the additively manufactured layer 15, with the additively manufactured layer 15 being formed on the base plate 7B.

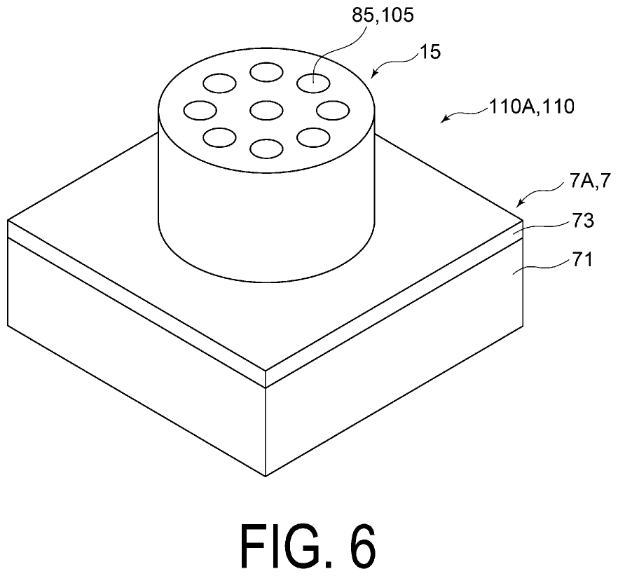

FIG. 6 is a schematic perspective view of the base plate 7A and the additively manufactured layer 15 illustrated in FIG. 5A.

Note that, in FIGS. 5A, 5B, and 6, the depiction of the configuration of the additive manufacturing apparatus 1 other than the base plate 7 and additively manufactured layer 15 is omitted.

By performing the additively manufactured layer forming step S30 according to some embodiments, an intermediate product 110 of the dissimilar material joining product 100 is produced as illustrated in FIGS. 5A, 5B, and 6.

The intermediate product 110 of the dissimilar material joining product 100 illustrated in FIGS. 5A, 5B, and 6 includes the substrate 71, the cladding layer 73, and the additively manufactured layer 15. The additively manufactured layer 15 and the cladding layer 73 illustrated in FIGS. 5A, 5B, and 6 are joined with sufficient joining strength.

In forming an additively manufactured layer on a base plate by additive manufacturing, when the combination of the metal material forming the base plate and the metal material forming the additively manufactured layer renders their joining by welding difficult, the joining strength between the base plate and the additively manufactured layer cannot be ensured, and the additively manufactured layer (fabricated object) peels from the base plate during manufacturing, and thus additive manufacturing cannot be continued.

With the additive manufacturing method according to some embodiments, even when the combination of the metal material forming the substrate 71 and the metal material forming the additively manufactured layer 15 renders their joining by welding difficult, if the main component element of the metal material forming the cladding layer 73 and the main component element of the metal material forming the additively manufactured layer 15 are the same, the additively manufactured layer 15 can be joined to the substrate 71 with relatively high strength with the cladding layer 73 interposed therebetween. Furthermore, if the metal material forming the cladding layer 73 and the metal material forming the additively manufactured layer 15 are a combination capable of producing a solid solution, a layer of the solid solution can be formed at the interface between the cladding layer 73 and the additively manufactured layer 15, and thus the additively manufactured layer 15 can be joined to the substrate 71 with relatively high strength with the cladding layer 73 interposed therebetween.

As a result, for example, even when the combination of the metal material forming the substrate 71 and the metal material forming the additively manufactured layer 15 is a combination that renders their joining by welding difficult, the additively manufactured layer 15 and the cladding layer 73 can be joined with relatively high joining strength. In other words, the joining strength of a portion, that is, the additively manufactured layer 15, formed of a dissimilar material having a different main component element from that of the substrate 71, can be improved in the dissimilar material joining product 100 including the substrate 71 and the additively manufactured layer 15. As a result, for example, even when the combination of the metal material forming the substrate 71 and the metal material forming the additively manufactured layer 15 is a combination that renders their joining by welding difficult, the additively manufactured layer 15 can be formed on the base plate 7 by additive manufacturing.

For example, an intermediate product 110A illustrated in FIGS. 5A and 6 may have a through-hole second region 85 formed in the additively manufactured layer 15. The through-hole second region 85 corresponds to a part of the through-holes 105 provided in the dissimilar material joining product 100, which is a product (finished product). For example, the through-holes 105 may be holes that penetrate through the dissimilar material joining product 100 across the substrate 71, the cladding layer 73, and the additively manufactured layer 15. That is, the through-hole first region 75 formed in the base plate 7A and the through-hole second region 85 formed in the additively manufactured layer 15 are preferably in communication.

Note that because the additively manufactured layer 15 is formed by additive manufacturing as described above, the through-hole second region 85 formed in the additively manufactured layer 15 may have a complex shape rather than a simple shape produced by drilling or discharging.

For example, an intermediate product 110B illustrated in FIG. 5B may have through-holes 95 formed in the additively manufactured layer 15, the through-holes 95 being provided in the dissimilar material joining product 100, which is a product (finished product).

Note that because the additively manufactured layer 15 is formed by additive manufacturing as described above, the through-holes 95 formed in the additively manufactured layer 15 may have a complex shape rather than a simple shape produced by drilling or discharging.

### Base Plate Processing Step S40

The base plate processing step S40 is a step of processing the base plate 7 to produce the dissimilar material joining product 100 including the substrate 71, the cladding layer 73, and the additively manufactured layer 15 after the additively manufactured layer forming step S30. In the base plate processing step S40, the intermediate product 110A removed from the additive manufacturing apparatus 1 is processed primarily to cut the base plate 7, for example, to produce the dissimilar material joining product 100, which is a product.

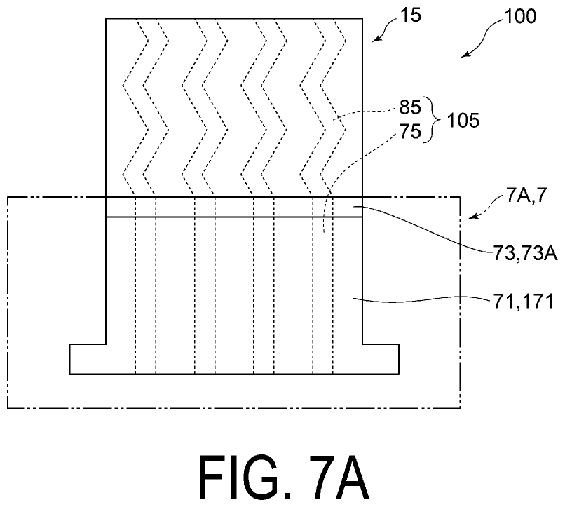

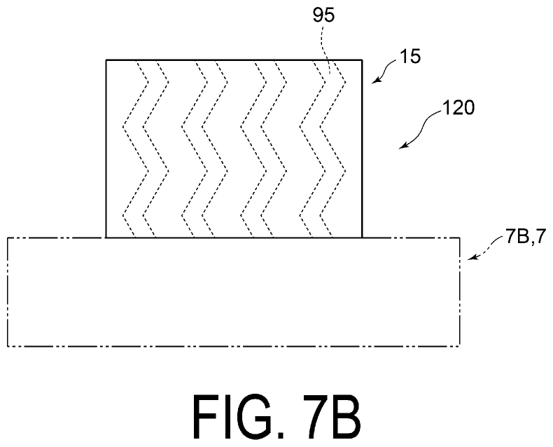

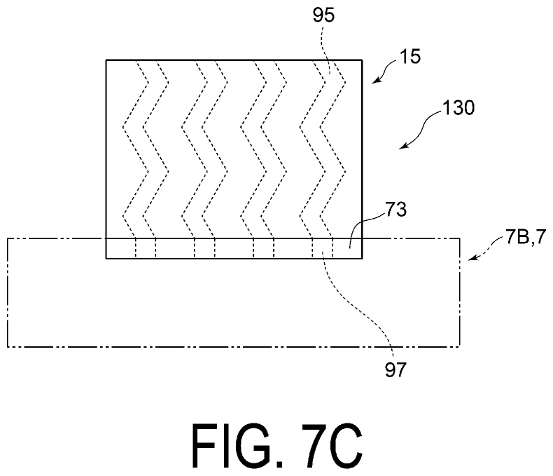

FIG. 7A is a schematic side view of the dissimilar material joining product 100 produced after cutting the base plate 7A of the intermediate product 110A illustrated in FIG. 5A, for example. In FIG. 7A, the shape of the base plate 7A before the processing of the base plate 7A in the base plate processing step S40 is indicated by a two-dot chain line.

With the additive manufacturing method according to some embodiments, the dissimilar material joining product 100 including the additively manufactured layer 15, the cladding layer 73, and the substrate 71 as a part of a product can be produced.

### Additively Manufactured Layer Separating Step S50

The additively manufactured layer separating step S50 is a step of separating the additively manufactured layer 15 formed on the cladding layer 73 from at least the substrate 71, after the additively manufactured layer forming step S30. In the additively manufactured layer separating step S50, the additively manufactured layer 15 and the cladding layer 73 may be separated with a wire saw or the like, for example. Additionally, in the additively manufactured layer separating step S50, at least a part of the cladding layer 73 and a portion including the additively manufactured layer 15 may be separated from at least the substrate 71 with a wire saw or the like.

FIG. 7B is a schematic side view of the additively manufactured layer 15 after the additively manufactured layer 15 and the cladding layer 73 are separated in the intermediate product 110B illustrated in FIG. 5B, for example, that is, an additive manufacturing product 120. In FIG. 7B, the shape of the base plate 7B before the separation of the additively manufactured layer 15 and the cladding layer 73 in the additively manufactured layer separating step S50 is indicated by a two-dot chain line.

FIG. 7C is a schematic side view of at least a part of the cladding layer 73 and the additively manufactured layer 15 after at least a part of the cladding layer 73 and a portion including the additively manufactured layer 15 are separated from at least the substrate 71 in the intermediate product 110B illustrated in FIG. 5B, that is, an additive manufacturing product 130. In FIG. 7C, the shape of the base plate 7B before the separation of at least a part of the cladding layer 73 and a portion including the additively manufactured layer 15 from at least the substrate 71 in the additively manufactured layer separating step S50 is indicated by a two-dot chain line.

Note that, for example, in a case where the through-holes 95 are formed in the additively manufactured layer 15 in the intermediate product 110B, through-holes 97 communicating with the through-holes 95 may be formed in the cladding layer 73 after at least a part of the cladding layer 73 and a portion including the additively manufactured layer 15 are separated from at least the substrate 71 in the additively manufactured layer separating step S50.

With the additive manufacturing method according to some embodiments, the additive manufacturing products 120, 130 can be produced that include at least the additively manufactured layer 15 but do not include at least the substrate 71 as a part of the products.

That is, with the additive manufacturing method according to some embodiments, even when the combination of the metal material forming the substrate 71 and the metal material forming the additively manufactured layer 15 is a combination that renders their joining by welding difficult, the additive manufacturing products 120, 130 that include at least the additively manufactured layer 15 can be produced.

### Dissimilar Material Joining Product 100

In the following description, a portion included in the substrate 71 of the base plate 7A in the above-described dissimilar material joining product 100 is referred to as a base material 171.

The dissimilar material joining product 100 illustrated in FIG. 7A includes the base material 171, the cladding layer 73 formed of a dissimilar material having a different main component element from that of the base material 171 and formed to cover at least a part of the base material 171, and the additively manufactured layer 15 formed of a dissimilar material having a different main component element from that of the base material 171 and joined to the base material 171 with the cladding layer 73 interposed therebetween.

The dissimilar material joining product 100 illustrated in FIG. 7A includes the base material 171, the cladding layer 73 formed of a dissimilar material having a different main component element from that of the base material 171 and formed to cover at least a part of the base material 171, and the additively manufactured layer 15 formed of a dissimilar material having a different main component element from that of the base material 171 and layered and fabricated on the cladding layer 73.

For example, in producing a dissimilar material joining product including two regions formed of metal materials that are different from each other, if the combination of the metal materials in the two regions is a combination that renders their joining by welding difficult, it is difficult to ensure joining strength between the two regions even if the joining of the two regions by welding is attempted, as described above. In addition, it is difficult to ensure the joining strength of the two regions even if attempting to form another region on one of the regions by additive manufacturing. Therefore, in producing a dissimilar material joining product including two regions formed of metal materials that are different from each other, if the combination of the metal materials in the two regions is a combination that renders their joining by welding difficult, the two regions need to be joined with fastening parts such as bolts to ensure sufficient joining strength. In this case, it is necessary to provide a portion for attaching the fastening parts in the dissimilar material joining product, for example, and this can cause such problems as constraints on shapes and the like in the dissimilar material joining product.

With the dissimilar material joining product 100 illustrated in FIG. 7A, even when the combination of the metal material forming the base material 171 and the metal material forming the additively manufactured layer 15 renders their joining by welding difficult, if the main component element of the metal material forming the cladding layer 73 and the main component element of the metal material forming the additively manufactured layer 15 are the same, the additively manufactured layer 15 can be joined to the base material 171 with relatively high strength with the cladding layer 73 interposed therebetween. Furthermore, if the metal material forming the cladding layer 73 and the metal material forming the additively manufactured layer 15 are a combination capable of producing a solid solution, a layer of the solid solution can be formed at the interface between the cladding layer 73 and the additively manufactured layer 15, and thus the additively manufactured layer 15 can be joined to the base material 171 with relatively high strength with the cladding layer 73 interposed therebetween.

As a result, for example, even when the combination of the metal material forming the base material 171 and the metal material forming the additively manufactured layer 15 is a combination that renders their joining by welding difficult, the joining strength between the base material 171 and the additively manufactured layer 15 with the cladding layer 73 interposed therebetween can be made relatively high in the dissimilar material joining product 100 illustrated in FIG. 7A. In other words, the joining strength of a portion formed of dissimilar materials having different main component elements can be improved in the dissimilar material joining product 100 including the portion.

Note that, in order to join the additively manufactured layer 15 to the base material with the cladding layer 73 interposed therebetween, the additively manufactured layer 15 may be formed on the cladding layer 73 by an additive manufacturing method such as the additive manufacturing method using the powder bed method or the additive manufacturing method using the LMD method. Furthermore, in order to join the additively manufactured layer 15 to the base material 171 with the cladding layer 73 interposed therebetween, a member formed as the additively manufactured layer 15 in advance, for example, may be joined to the cladding layer 73 by welding or the like.

In the dissimilar material joining product 100 illustrated in FIG. 7A, the combination of the material constituting the base material 171 and the material constituting the additively manufactured layer 15 may be a combination that produces an intermetallic compound when these materials solidify after being melted.

As described above, when the combination of the material constituting the base material 171 and the material constituting the additively manufactured layer 15 is a combination that produces an intermetallic compound when these materials solidify after being melted, it is difficult to directly join the base material 171 and the additively manufactured layer 15 by welding or the like.

With the dissimilar material joining product 100 illustrated in FIG. 7A, the joining strength between the base material 171 and the additively manufactured layer 15 with the cladding layer 73 interposed therebetween can be made relatively high.

In the dissimilar material joining product 100 illustrated in FIG. 7A, the main component element of the material constituting the additively manufactured layer 15 and the main component element of the material constituting the cladding layer 73 may be the same.

As a result, the joining strength between the additively manufactured layer 15 and the cladding layer 73 can be made relatively high, and thus the joining strength between the base material 171 and the additively manufactured layer 15 with the cladding layer 73 interposed therebetween can be made relatively high.

In the dissimilar material joining product 100 illustrated in FIG. 7A, the combination of the material constituting the additively manufactured layer 15 and the material constituting the cladding layer 73 may be a combination that produces a solid solution when these materials solidify after being melted.

As a result, the joining strength between the additively manufactured layer 15 and the cladding layer 73 can be made relatively high, and thus the joining strength between the base material 171 and the additively manufactured layer 15 with the cladding layer 73 interposed therebetween can be made relatively high.

In the dissimilar material joining product 100 illustrated in FIG. 7A, the cladding layer 73 may be an explosive welding layer 73A formed on the base material 171.

As a result, the joining strength between the base material 171 and the cladding layer 73 is relatively high. Furthermore, even when the combination of the metal material forming the base material 171 and the metal material forming the cladding layer 73 is a combination that renders their joining by welding difficult, the joining strength between the base material 171 and the cladding layer 73 is relatively high. Thus, the joining strength between the base material 171 and the additively manufactured layer 15 with the cladding layer 73 interposed therebetween can be made relatively high.

With the dissimilar material joining product 100 illustrated in FIG. 7A, the material constituting the base material 171 may be a ferrous material, and the material constituting the cladding layer 73 may be a titanium-based material.

A combination of a ferrous material and a titanium-based material is a combination that produces an intermetallic compound when these materials solidify after being melted. Therefore, it is difficult to join the additively manufactured layer 15, which is formed of a titanium-based material, to the base material 171 by welding, additive manufacturing, or the like.

With the dissimilar material joining product 100 illustrated in FIG. 7A, since the material constituting the cladding layer 73 is a titanium-based material, the joining strength between the cladding layer 73 and the additively manufactured layer 15, which is formed of a titanium-based material, is relatively high. Thus, with the dissimilar material joining product 100 illustrated in FIG. 7A, the joining strength between the base material 171, formed of a ferrous material, and the additively manufactured layer 15, formed of a titanium-based material, with the cladding layer 73 interposed therebetween can be made relatively high.

The disclosure is not limited to the above-described embodiments, and includes embodiments obtained by modifying the above-described embodiments and embodiments obtained by appropriately combining these embodiments.

For example, while the powder bed method is employed as an example of the additive manufacturing method in some embodiments described above, the additive manufacturing method may be an additive manufacturing method using the LMD method.

Furthermore, in some embodiments described above, the metal material of the raw material powder 30 (the metal material of the additively manufactured layer 15) is, for example, an alloy, and the metal material forming the cladding layer 73 is a pure metal. Alternatively, the metal material of the raw material powder 30 (the metal material of the additively manufactured layer 15) and the metal material forming the cladding layer 73 may be an alloy having the same main component element. Note that in this case, if two or more types of main component elements are contained, the content of each of the main component elements in the metal material of the raw material powder 30 (the metal material of the additively manufactured layer 15) does not necessarily match the content of each of the main component elements in the metal material forming the cladding layer 73. Furthermore, the metal material of the raw material powder 30 (the metal material of the additively manufactured layer 15) and the metal material forming the cladding layer 73 may have different contents of elements other than the main component elements and may contain elements other than the main component elements.

The metal material of the raw material powder 30 (the metal material of the additively manufactured layer 15) and the metal material forming the cladding layer 73 may be a pure metal having the same main component element.

The contents described in each of the above embodiments are understood as follows, for example.

(1) The dissimilar material joining product 100 according to at least one embodiment of the disclosure includes the base material 171, the cladding layer 73 formed of a dissimilar material having a different main component element from that of the base material 171 and formed to cover at least a part of the base material 171, and the additively manufactured layer 15 formed of a dissimilar material having a different main component element from that of the base material 171 and joined to the base material 171 with the cladding layer 73 interposed therebetween.

With the configuration (1) described above, even when the combination of the metal material forming the base material 171 and the metal material forming the additively manufactured layer 15 renders their joining by welding difficult, if the main component element of the metal material forming the cladding layer 73 and the main component element of the metal material forming the additively manufactured layer 15 are the same, the additively manufactured layer 15 can be joined to the base material 171 with relatively high strength with the cladding layer 73 interposed therebetween. Furthermore, if the metal material forming the cladding layer 73 and the metal material forming the additively manufactured layer 15 are a combination capable of producing a solid solution, a layer of the solid solution can be formed at the interface between the cladding layer 73 and the additively manufactured layer 15, and thus the additively manufactured layer 15 can be joined to the base material 171 with relatively high strength with the cladding layer 73 interposed therebetween.

As a result, for example, even when the combination of the metal material forming the base material 171 and the metal material forming the additively manufactured layer 15 is a combination that renders their joining by welding difficult, the joining strength between the base material 171 and the additively manufactured layer 15 with the cladding layer 73 interposed therebetween can be made relatively high in the dissimilar material joining product 100 with the configuration (1) described above. In other words, the joining strength of a portion formed of dissimilar materials having different main component elements can be improved in the dissimilar material joining product 100 including the portion.

(2) The dissimilar material joining product 100 according to at least one embodiment of the disclosure includes the base material 171, the cladding layer 73 formed of a dissimilar material having a different main component element from that of the base material 171 and formed to cover at least a part of the base material 171, and the additively manufactured layer 15 formed of a dissimilar material having a different main component element from that of the base material 171 and layered and fabricated on the cladding layer 73.

With the configuration (2) described above, for example, even when the combination of the metal material forming the base material 171 and the metal material forming the additively manufactured layer 15 is a combination that renders their joining by welding difficult, the joining strength between the base material 171 and the additively manufactured layer 15 with the cladding layer 73 interposed therebetween can be made relatively high in the dissimilar material joining product 100 with the configuration (2) described above. In other words, the joining strength of a portion formed of dissimilar materials having different main component elements can be improved in the dissimilar material joining product 100 including the portion.

(3) According to some embodiments, in the configuration (1) or (2) described above, the combination of the material constituting the base material 171 and the material constituting the additively manufactured layer 15 may be a combination that produces an intermetallic compound when they solidify after being melted.

With the configuration (3) described above, which includes the configuration (1) or (2) described above, the joining strength between the base material 171 and the additively manufactured layer 15 with the cladding layer 73 interposed therebetween can be made relatively high.

(4) In some embodiments, in any of the configurations (1) to (3) described above, the material constituting the additively manufactured layer 15 and the material constituting the cladding layer 73 may have the same main component element.

With the configuration (4) described above, the joining strength between the additively manufactured layer 15 and the cladding layer 73 can be made relatively high, and thus the joining strength between the base material 171 and the additively manufactured layer 15 with the cladding layer 73 interposed therebetween can be made relatively high.

(5) In some embodiments, in any of the configurations (1) to (3) described above, the combination of the material constituting the additively manufactured layer 15 and the material constituting the cladding layer 73 may be a combination that produces a solid solution when they solidify after being melted.

With the configuration (5) described above, the joining strength between the additively manufactured layer 15 and the cladding layer 73 can be made relatively high, and thus the joining strength between the base material 171 and the additively manufactured layer 15 with the cladding layer 73 interposed therebetween can be made relatively high.

(6) In some embodiments, in any of the configurations (1) to (5) described above, the cladding layer 73 may be the explosive welding layer 73A formed on the base material 171.

With the configuration (6) described above, the joining strength between the base material 171 and the cladding layer 73 is relatively high. Furthermore, even when the combination of the metal material forming the base material 171 and the metal material forming the cladding layer 73 is a combination that renders their joining by welding difficult, the joining strength between the base material 171 and the cladding layer 73 is relatively high. Thus, the joining strength between the base material 171 and the additively manufactured layer 15 with the cladding layer 73 interposed therebetween can be made relatively high.

(7) In some embodiments, in any of the configurations (1) to (6) described above, the material constituting the base material 171 may be a material containing iron as the main component element, and the material constituting the cladding layer 73 may be a material containing titanium as the main component element.

A combination of a ferrous material and a titanium-based material is a combination that produces an intermetallic compound when these materials solidify after being melted. Therefore, it is difficult to join the additively manufactured layer 15, which is formed of a titanium-based material, to the base material 171 by welding, additive manufacturing, or the like.

With the configuration (7) described above, since the material constituting the cladding layer 73 is a titanium-based material, the joining strength between the cladding layer 73 and the additively manufactured layer 15, which is formed of a titanium-based material, is relatively high. Thus, with the configuration (7) described above, the joining strength between the base material 171, formed of a ferrous material, and the additively manufactured layer 15, formed of a titanium-based material, with the cladding layer 73 interposed therebetween can be made relatively high.

(8) In some embodiments, in any of the configurations (1) to (7) described above, the cladding layer 73 may have a thickness of 0.5 mm or more and 5 mm or less.

With the configuration (8) described above, the cladding layer 73 has an appropriate thickness.

(9) The base plate 7 for additive manufacturing according to at least one embodiment of the disclosure includes the substrate 71 and the cladding layer 73 formed of a dissimilar material having a different main component element from that of the substrate 71 and formed to cover at least a part of the substrate 71.

With the configuration (9) described above, even when the combination of the metal material forming the substrate 71 and the metal material forming the additively manufactured layer 15 renders their joining by welding difficult, if the main component element of the metal material forming the cladding layer 73 and the main component element of the metal material forming the additively manufactured layer 15 are the same, the additively manufactured layer 15 can be joined to the substrate 71 with relatively high strength with the cladding layer 73 interposed therebetween. Furthermore, if the metal material forming the cladding layer 73 and the metal material forming the additively manufactured layer 15 are a combination capable of producing a solid solution, a layer of the solid solution can be formed at the interface between the cladding layer 73 and the additively manufactured layer 15, and thus the additively manufactured layer 15 can be joined to the substrate 71 with relatively high strength with the cladding layer 73 interposed therebetween.

As a result, for example, even when the combination of the metal material forming the substrate 71 and the metal material forming the additively manufactured layer 15 is a combination that renders their joining by welding difficult, the joining strength between the substrate 71 and the additively manufactured layer 15 with the cladding layer 73 interposed therebetween can be made relatively high. In other words, the joining strength of a portion, that is, the additively manufactured layer 15, formed of a dissimilar material having a different main component element from that of the substrate 71, can be improved in the dissimilar material joining product 100 including the substrate 71 and the additively manufactured layer 15. As a result, for example, even when the combination of the metal material forming the substrate 71 and the metal material forming the additively manufactured layer 15 is a combination that renders their joining by welding difficult, the additively manufactured layer 15 can be formed on the base plate 7 for additive manufacturing by additive manufacturing.

(10) In some embodiments, in the configuration (9) described above, the thickness tb of the substrate 71 may be greater than the thickness tc of the cladding layer 73, and Young's modulus of the material constituting the substrate 71 may be greater than Young's modulus of the material constituting the cladding layer 73.

With the configuration (10) described above, even when the metal material constituting the cladding layer 73 is more expensive than the metal material constituting the substrate 71, the strength of the base plate 7 for additive manufacturing can be ensured while suppressing an increase in cost.

(11) The additive manufacturing apparatus 1 according to at least one embodiment of the disclosure includes the base plate 7 for additive manufacturing having the configuration (9) or (10) described above.

With the configuration (11) described above, for example, even when the combination of the metal material forming the substrate 71 and the metal material forming the additively manufactured layer 15 is a combination that renders their joining by welding difficult, the additively manufactured layer 15 can be formed on the base plate 7 for additive manufacturing by additive manufacturing.

(12) An additive manufacturing method according to at least one embodiment of the disclosure includes a step (additively manufactured layer forming step S30) of forming the additively manufactured layer 15 on the cladding layer 73 by melting, with an energy beam (light beam 65), the raw material (raw material powder 30) of a dissimilar material having a different main component element from that of the substrate 71 on the base plate 7 for additive manufacturing and solidifying the raw material, including the substrate 71 and the cladding layer 73 formed of a dissimilar material having a different main component element from that of the substrate 71 and formed to cover at least a part of the substrate 71, with an energy beam.

With the method (12) described above, even when the combination of the metal material forming the substrate 71 and the metal material forming the additively manufactured layer 15 renders their joining by welding difficult, if the main component element of the metal material forming the cladding layer 73 and the main component element of the metal material forming the additively manufactured layer 15 are the same, the additively manufactured layer 15 can be joined to the substrate 71 with relatively high strength with the cladding layer 73 interposed therebetween. Furthermore, if the metal material forming the cladding layer 73 and the metal material forming the additively manufactured layer 15 are a combination capable of producing a solid solution, a layer of the solid solution can be formed at the interface between the cladding layer 73 and the additively manufactured layer 15, and thus the additively manufactured layer 15 can be joined to the substrate with relatively high strength with the cladding layer 73 interposed therebetween.

As a result, for example, even when the combination of the metal material forming the substrate 71 and the metal material forming the additively manufactured layer 15 is a combination that renders their joining by welding difficult, the additively manufactured layer 15 and the cladding layer 73 can be joined with relatively high joining strength. In other words, the joining strength of a portion, that is, the additively manufactured layer 15, formed of a dissimilar material having a different main component element from that of the substrate 71, can be improved in the dissimilar material joining product 100 including the substrate 71 and the additively manufactured layer 15. As a result, for example, even when the combination of the metal material forming the substrate 71 and the metal material forming the additively manufactured layer 15 is a combination that renders their joining by welding difficult, the additively manufactured layer 15 can be formed on the base plate 7 for additive manufacturing by additive manufacturing.

(13) In some embodiments, the method (12) described above may also include a step (base plate processing step S40) of processing the base plate 7 for additive manufacturing to obtain the dissimilar material joining product 100 including the substrate 71, the cladding layer 73, and the additively manufactured layer 15 after the step (additively manufactured layer forming step S30) of forming the additively manufactured layer 15.

With the method (13) described above, the dissimilar material joining product 100 including the additively manufactured layer 15, the cladding layer 73, and the substrate 71 as a part of a product can be produced.

(14) In some embodiments, the method (12) described above may also include a step (additively manufactured layer separating step S50) of separating the additively manufactured layer 15 formed on the cladding layer 73 from at least the substrate 71 after the step (additively manufactured layer forming step S30) of forming the additively manufactured layer 15.

With the method (14) described above, the additive manufacturing products 120, 130 can be produced that include at least the additively manufactured layer 15 but do not include at least the substrate 71 as a part of the products.

(15) In some embodiments, any of the methods (12) to (14) described above may also include a step (base plate acquiring step S10) of forming the cladding layer 73 on the substrate 71 to produce the base plate 7 for additive manufacturing.

With the method (15) described above, the base plate 7 for additive manufacturing is produced that includes the substrate 71 and the cladding layer 73 formed of a dissimilar material having a different main component element from that of the substrate 71 and formed to cover at least a part of the substrate 71.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A dissimilar material joining product comprising:
a base material;
a cladding layer formed of a dissimilar material having a different main component element from that of the base material and formed to cover at least a part of the base material; and
an additively manufactured layer formed of a dissimilar material having a different main component element from that of the base material and joined to the base material with the cladding layer interposed therebetween.

2. The dissimilar material joining product according to claim 1, wherein a combination of a material constituting the base material and a material constituting the additively manufactured layer is a combination that produces an intermetallic compound when the materials solidify after being melted.

3. The dissimilar material joining product according to claim 1, wherein the material constituting the additively manufactured layer and a material constituting the cladding layer have the same main component element.

4. The dissimilar material joining product according to claim 1, wherein a combination of the material constituting the additively manufactured layer and a material constituting the cladding layer is a combination that produces a solid solution when the materials solidify after being melted.

5. The dissimilar material joining product according to claim 1, wherein the cladding layer is an explosive welding layer formed on the base material.

6. The dissimilar material joining product according to claim 1, wherein the material constituting the base material is a material containing iron as the main component element, and the material constituting the cladding layer is a material containing titanium as the main component element.

7. The dissimilar material joining product according to claim 1, wherein the cladding layer has a thickness of 0.5 mm or more and 5 mm or less.

8. A base plate for additive manufacturing comprising:
a substrate; and
a cladding layer formed of a dissimilar material having a different main component element from that of the substrate and formed to cover at least a part of the substrate.

9. The base plate for additive manufacturing according to claim 8, wherein a thickness of the substrate is greater than a thickness of the cladding layer, and
Young's modulus of a material constituting the substrate is greater than Young's modulus of a material constituting the cladding layer.

10. An additive manufacturing apparatus comprising the base plate for additive manufacturing according to claim 8.

11. An additive manufacturing method comprising a step of forming an additively manufactured layer on a cladding layer by melting, with an energy beam, a raw material of a dissimilar material having a different main component element from that of a substrate on a base plate for additive manufacturing and solidifying the raw material, including the substrate and the cladding layer formed of a dissimilar material having a different main component element from that of the substrate and formed to cover at least a part of the substrate.

12. The additive manufacturing method according to claim 11, further comprising a step of processing the base plate for additive manufacturing to obtain a dissimilar material joining product including the substrate, the cladding layer, and the additively manufactured layer after the step of forming the additively manufactured layer.

13. The additive manufacturing method according to claim 11, further comprising a step of separating the additively manufactured layer formed on the cladding layer from at least the substrate after the step of forming the additively manufactured layer.

14. The additive manufacturing method according to claim 11, further comprising a step of forming the cladding layer on the substrate to produce the base plate for additive manufacturing.
